(19) United States
(12) Patent Application Publication
(10) Pub. No.: US 2002/0049618 A1
(43) Pub. Date: Apr. 25, 2002

(54) Method and computer system for generating historical claims loss data reports

(76) Inventors: Darin Scoville McClure, Macon, GA (US); Kelly Cole Thomason, Macon, GA (US)

Correspondence Address: MERCHANT & GOULD P.C., P.O. Box 2903, Minneapolis, MN, 55402-0903, US

(21) Appl. No.: 09/919,339

(22) Filed: Jul. 31, 2001

Related U.S. Application Data
(60) Provisional application No. 60/222,078, filed on Aug. 1, 2000.

(51) Int. Cl. G06F 17/60

(52) U.S. Cl. 705/4

(57) ABSTRACT

A method and computer system for generating historical claims loss data reports is disclosed. A method and computer system allows a user, via the Internet and facsimile authorization procedures, to obtain electronic historical claims loss data reports. A server Website, after obtaining the proper information from the user, queries insurance carriers databases, generates the reports, and distributes the reports. The reports are comprehensive; they provide summary reports which combine loss run data from a plurality of insurance carriers and they provide detail reports which disclose the details of each claim for each line of business..

### RELATED APPLICATIONS

This application claims the benefit of U.S. Provisional application Ser. No. 60/222,078 filed Aug. 1, 2000.

### TECHNICAL FIELD

This invention generally relates to a method and computer system for generating historical claims loss data reports.

### BACKGROUND

The commercial insurance industry has seen many changes in recent years. Most of these changes have reduced the cost of the distribution of information and have increased the accuracy of that information. One area of the commercial insurance industry, however, that has not evolved is the collection and distribution of historical claims loss data [hereinafter “loss runs”].

Loss runs act as an insured's liability “credit rating.” Insurance company underwriters utilize these loss runs to determine account desirability and pricing concessions. Loss runs, therefore, are a vital component of the underwriting process.

The current process of securing loss runs reports for an insured is problematic. The process includes the following steps: (1) the insured or an agent on behalf of the insured sends a written request to the incumbent and prior insurance carriers; (2) those carriers print out a historical report of the insured's claims; (3) this report is forwarded to either the incumbent agent, the insured, or in some cases, the competing agent trying to write the account; and (4) the report eventually reaches the competing agent who then forwards the report to all insurance carriers from whom he has solicited pricing quotations.

The current process has several problems:

(A) Insurance Carrier's Reports Vary in Format

All carriers use reports created internally by their company. These reports lack a common format. Labor intensive deciphering, therefore, is necessary to assimilate the information as a whole.

(B) Delays in Receiving Reports

Most states have enacted laws that require carriers to deliver loss run reports at the request of the insured. The carriers typically mail the reports to the insured's incumbent agent who is then responsible for promptly forwarding it to the insured. The incumbent agent has an incentive to delay the transmission of the reports because such delays stifle competition.

(C) Obtaining Reports is Labor Intensive

Medium to large sized commercial entities may have multiple insurance companies insuring different lines of coverage each year. An incumbent or competing agent must separately request a loss runs report from each insurance company for each line of coverage for each year of coverage. One must ask the insured to sign loss run request letters, forward those letters, and then follow up with the companies until loss run information is received from each carrier contacted. This process is very labor intensive.

(D) Accuracy of the Report

Competing agents often work on commission. Reports, therefore, are sometimes “modified” by competing agents to create a more favorable report.

### SUMMARY OF INVENTION

The present invention, in different embodiments, will solve the above listed problems. The invention is a central claims data clearinghouse that acquires and distributes loss runs in a universal report to insured entities, agents, and insurance company underwriters.

The present invention, in one embodiment, is a computer system comprising a server Website, a database, a routing system, carrier databases, and a user device. The user device connects to the server Website over the Internet via a browser. The server Website communicates with the carrier databases via a wide range communications link. The server Website is connected to the database, which may be local or remote. The server Website is interfaced with the routing system. The server Website, in this environment, generates historical claim loss data reports which combine loss runs from multiple carriers over multiple years.

In one embodiment, the method begins with the user, through user interfaces, inputting a customer's information, choosing a report request for that customer, and creating a notification list on the server Website over the Internet. The user then obtains the insured's authorization. In one embodiment, this involves the server Website generating an authorization letter, the user printing the authorization letter, the insured signing the authorization letter, and the user returning, via facsimile, the signed authorization letter. Thereafter, the server Website queries the carriers'databases for the requested loss runs. Then, the server Website, through carrier dependent protocols, standardizes and stores the retrieved loss runs. Next, the server Website generates a universal report. Finally, the server Website distributes the reports over the Internet.

The advantages to the system of the present invention include:

(A) A Single Loss Run Report

A universal loss run report that combines loss runs from multiple carriers over multiple years providing a quick and comprehensive understanding of the insured's loss experience.

(B) No Time Delays

The system and method of the present invention will, with proper authorization, generate reports overnight.

(C) Decreased Direct and Indirect Acquisition Costs

The system and method will decrease the associated labor costs of generating loss runs reports by replacing manual processes with automated processes.

(D) Integrity of Data

The underwriters will have greater confidence in the accuracy of the data because the competing agent never handles the loss runs reports.

(E) Multiple Access to Data

Both carriers and agents will be able to analyze their customers and their competition with the present invention. The carriers that treat distribution of claim reports only as an expense will now receive monthly reports summarizing and analyzing characteristics and trends about their insured clients.

These and other features, advantages, and aspects of the present invention may be more clearly understood and appreciated from a review of the following detailed description of the disclosed embodiments and by reference to the appended drawings and claims.

### BRIEF DESCRIPTION OF THE DRAWINGS

FIG. 1 is a block diagram of an exemplary computer system for implementing an embodiment of the invention.

FIG. 2 is a exemplary user device for implementing an embodiment of the invention.

FIG. 3 is a flow chart illustrating the exemplary steps for generating a single historical loss runs report in accordance with an embodiment of the invention.

FIG. 4 is a diagram of the standard formatted record in accordance with an embodiment of the invention.

FIG. 5 is a diagram of the fields in a typical carrier database.

FIG. 6 is a diagram demonstrating the flow of data from the carriers'databases to the finished historical loss runs reports in accordance with an embodiment of the invention.

FIG. 7 is a diagram of the fields in the server Website database, the detail reports, and the summary reports in accordance with an embodiment of the invention.

FIG. 8 is an example of a detail report in accordance with an embodiment of the invention.

FIG. 9 is an example of a summary report in accordance with an embodiment of the invention.

### DETAILED DESCRIPTION OF THE EMBODIMENTS OF THE INVENTION

In the following detailed description numerous specific details are set forth in order to provide a thorough understanding of the present invention. It will be understood by those skilled in the art, though, that the present invention may be practiced without these specific details. In other instances well known methods, procedures, components, and circuits have not been described in detail so as not to obscure the present invention.

### Exemplary Operating Environment

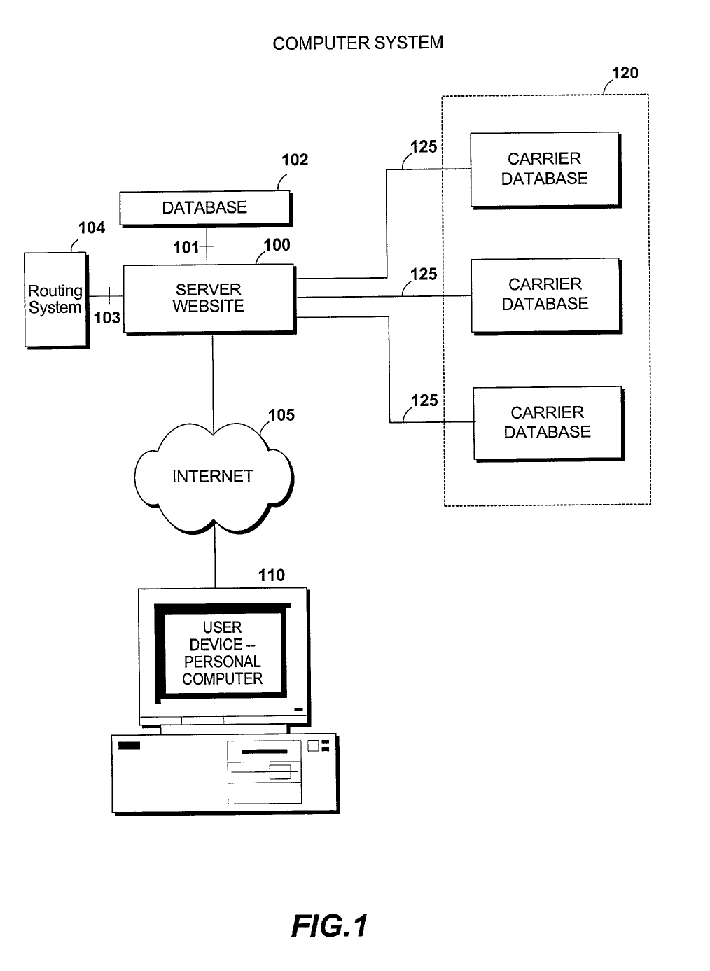

FIG. 1 is a schematic block diagram of a computer system that implements the preferred embodiment of this invention. The computer system comprises a server Website 100, a database 102, a routing system 104, at least one user device 110, and a plurality of carrier databases 120. The carrier databases are owned and operated by insurance carriers, e.g., AIG, CNA, and Travelers. The user device is a personal computer. The server Website is connected to the database 101, which may be remote or local. The server Website and routing system are interfaced 103. The server Website and carrier databases communicate by means of a wide range network communications mechanism 125, e.g., ATM or TCP/IP. The user device connects to the server Website on the Internet 105 via a browser.

As will be understood by those skilled in the art, the computer system may be embodied in other specific forms without departing from the spirit or essential characteristics of this invention. For example, those skilled in the art will appreciate that many other devices will sufficiently serve as the user device, e.g., hand-held devices, multiprocessor systems, microprocessor-based or programmable consumer electronics, network personal computers, minicomputers, mainframe computers, and the like.

The embodied personal computer and Internet will be discussed in detail below for background information.

### Personal Computer

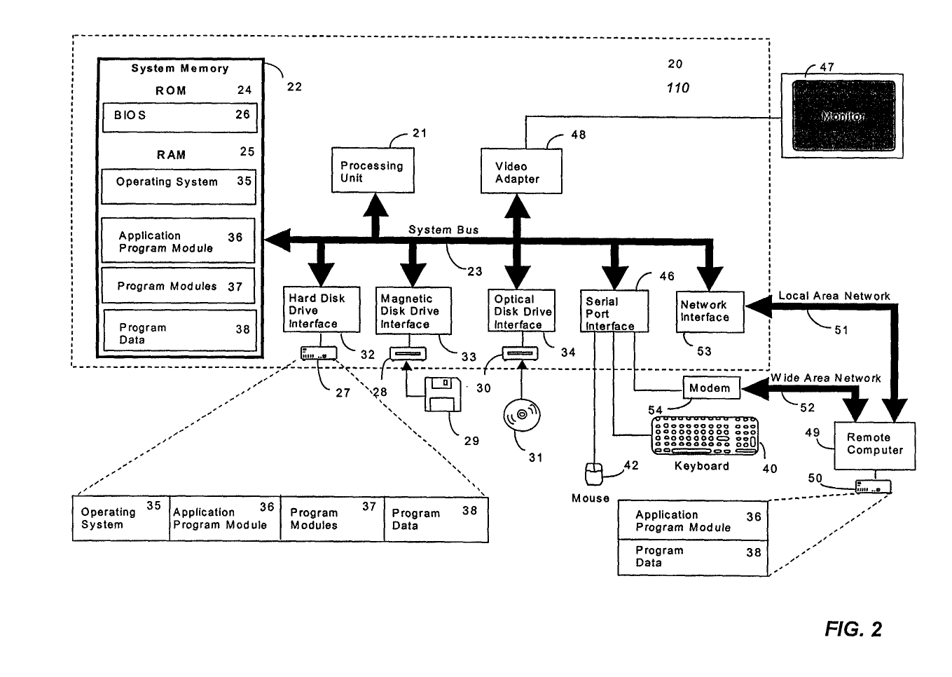

With reference to FIG. 2, an exemplary user device is a general purpose computing device in the form of a conventional personal computer 110, including a processing unit 21, a system memory 22, and a system bus 23 that couples various system components including the system memory to the processing unit 21. The system bus 23 may be any of several types of bus structures including a memory bus or memory controller, a peripheral bus, and a local bus using any of a variety of bus architectures. The system memory includes read only memory (ROM) 24 and random access memory (RAM) 25. A basic input/output system 26 (BIOS), containing the basic routines that help to transfer information between elements within the personal computer 20, such as during start-up, is stored in ROM 24.

The personal computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD-ROM or other optical media. The hard disk drive 27, magnetic disk drive 28 and optical disk drive 30 are connected to the system bus 23 by a hard disk drive interface 32, a magnetic disk drive interface 33 and an optical drive interface 34, respectively. The drives and their associated computer-readable media provide nonvolatile storage of computer readable instructions, data structures, program modules and other data for the personal computer 20.

Although the exemplary environment described herein employs a hard disk, a removable magnetic disk 29 and a removable optical disk 31, it should be appreciated by those skilled in the art that other types of computer readable media which can store data that is accessible by a computer, such as magnetic cassettes, flash memory cards, digital video disks, Bernoulli cartridges, random access memories (RAMs), read only memories (ROMs), and the like, may also be used in the exemplary operating environment.

A number of program modules may be stored on the hard disk, magnetic disk 29, optical disk 31, ROM 24 or RAM 25, including an operating system 35, one or more application programs 36, other program modules 37, and program data 38. In a preferred embodiment, the application programs 36 comprise the “OFFICE XP” suite of program modules.

A user may enter commands and information into the personal computer 20 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port or a universal serial port (USB). A monitor 47 or other type of display device is also connected to the system bus 23 via an interface, such as a video adapter 48. In addition to the monitor, personal computers typically include other peripheral output devices (not shown), such as speakers and printers.

The personal computer 20 may operate in a networked environment using logical connections to one or more remote computers, such as a remote computer 49. The remote computer 49 may be another personal computer, a server, a router, a network PC, a peer device or other common network node, and typically includes many or all of the elements described above relative to the personal computer 20, although only a memory storage device 50 has been illustrated in FIG. 1. The logical connections depicted in FIG. 1 include a local area network (LAN) 51 and a wide area network (WAN) 52. Such networking environments are commonplace in offices, enterprise-wide computer networks, intranets and the Internet.

When used in a LAN networking environment, the personal computer 20 is connected to the local network 51 through a network interface or adapter 53. When used in a WAN networking environment, the personal computer 20 typically includes a modem 54 or other means for establishing communications over the wide area network 52, such as the Internet. The modem 54, which may be internal or external, is connected to the system bus 23 via the serial port interface 46. In a networked environment, program modules depicted relative to the personal computer 20, or portions thereof, may be stored in the remote memory storage device. It will be appreciated that the network connections shown are exemplary and other means of establishing a communications link between the computers may be used.

### Internet

Referring again to FIG. 1, the server Website 100 is a node on the Internet 105, a global computer-implemented network. A network router may be used to connect the server Website to the Internet for controlling the flow of data. Also connected to the Internet is a plurality of nodes, such as personal computers, Web devices, etc., under control by users. The users communicate with the server Website using dial-up modems, cable modems, ISDN, DSL, etc., and using browser programs executing on their personal computers. Communication links or sessions are established between the users and the server, via the Internet, when the users log onto the server Website.

### Method For Generating A Historical Loss Claims Report

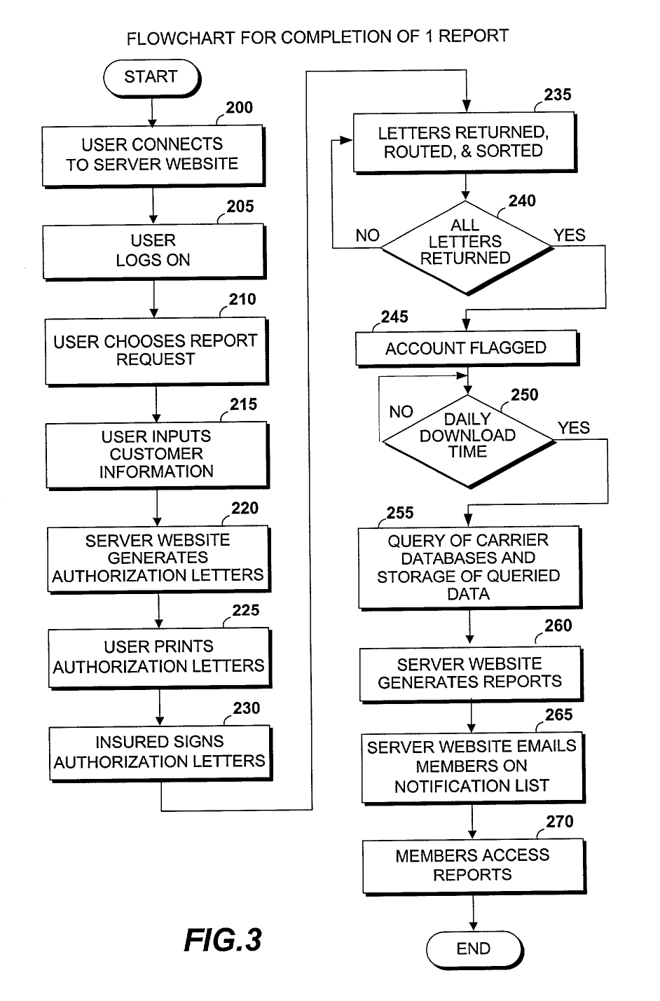

The present invention is a computer system and method for generating a loss runs report. The steps of the preferred embodiment will be explained in detail with reference to FIG. 3. The following procedure generates a single loss runs report. The server Website, as is well-known in the art, is capable of handling such procedures in parallel to simultaneously produce multiple loss runs reports.

### Logging On

First, the user connects to the server Website on the Internet via a web browser program (Step 200). That is, the user selects and enters the URL address of the server Website on his computer, and a communication link is established between the user and the server Website. The server Website, through that communication link, transfers data to the client's browser for display on the user's display monitor.

After establishing a communication link, the user, through a user interface, is able to logon to the server Website (Step 205). The user interface requires the user to input a Login Name and Password. The server Website, based on the inputted Login Name and Password, grants or denies the user access to the secured area. The secured area consists of any further access to the server Website. The invention may be implemented with other security features well-known to those skilled in the art. For example, the logon features of this invention may be supplemented with online subscribing, that is, users may create Logon Names and Passwords through registration interfaces.

### Request Report

After logging into the secured area, a user, through a user menu-driven interface on the server Website, chooses a report request (Step 210). Report requests specify the report format and specify other details of the report such as the policies and policy years requested. Then, the user, through a user interface on the server Website, creates a notification list. The notification list comprises of parties and their contact information, email address and facsimile number. These parties are contacted upon completion of the report. It should be understood that, in other embodiments, the invention may be implemented without Step 210. For example, the server Website may implement a default setting application that, based on prior sales, pre-selects a report request, pre-selects a notification list, and then skips Step 210.

### Input Customer Information

After choosing a report request, the user, through a user interface on the server Website, inputs customer information (Step 215). Customer information is information about the insured; it may include but is not limited to: insured's name, insured's address, insured's phone number, each policy period, carrier for each period, policy number for each period, and type of policy for each period. The preferred embodiment implements a database on the server Website comprising of accounts for each customer. The server Website stores the customer's information and other data relating to that customer in the corresponding account. The invention may implement numerous other storage procedures well-known to those skilled in the art.

### Authorization

After inputting the customer information, the insured must authorize the release of the loss runs data from the carriers (Steps 220 through 245). Pursuant to state laws carriers are obligated to release loss runs at the insured party's request. The request currently must be in writing and signed by the insured party.

The authorization procedure of the preferred embodiment begins with the server Website generating, through an application stored on the server Website, an authorization letter (Step 220). The generated authorization letter is unique in that each authorization letter includes a unique tracking number or bar code. The user prints out the authorization letter (Step 225). The user then obtains the insured's signature on the authorization letter (Step 230) and returns the signed authorization letter via facsimile to the routing system (Step 235). While the preferred embodiment uses only one authorization letter per insured, other embodiments may use a plurality of authorization letters per insured.

A routing system automatically routes the returned authorization letters by their tracking numbers or bar codes to corresponding account locations (Step 235). The routing may be done in a number of ways well-known to those skilled in the art. In the preferred embodiment, the routing system contains a facsimile server. After the facsimile server receives returned authorization letters, the letters are manually confirmed as properly signed. Then, the confirmed letters are routed according to their tracking number or bar code.

An interface between the routing system and server Website, well-known to those skilled in the art, allows the server Website to determine whether the routing system has received the authorization letter for an account (Step 240). When the routing system has received the authorization letter for an account, the server Website is authorized to query the carrier databases for the requested loss runs. Thus, when the authorization letter for an account is received, the server Website flags that account as authorized (Step 245).

This invention may also implement the authorization process in other ways as known in the art. For example, the invention may implement an electronic signature process to obtain authorization.

### Query of Carrier Databases and Storage of Loss Runs

After completing the authorization process, the server Website is ready to query the carrier databases for the requested loss runs. At a predetermined daily time (Step 250), the server Website queries the carrier databases for the flagged accounts requested loss runs (Step 255).

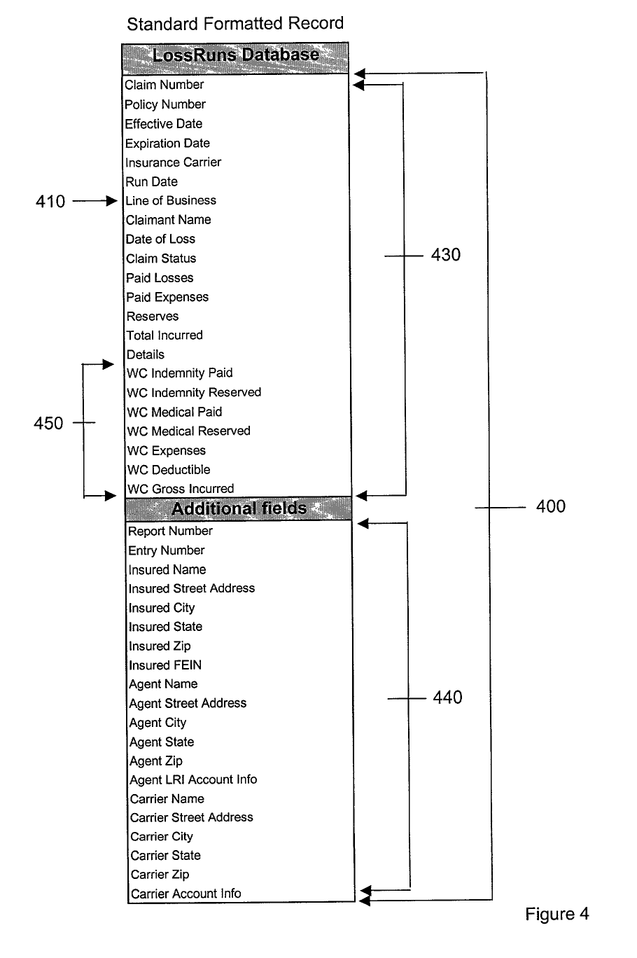

Protocols map the queried loss runs, which are in records of different format, into records of one format. Different carriers store loss runs in different record formats. Referring to FIG. 4, this invention, in one embodiment, stores loss runs in only one record format [hereinafter “standard format”] 400. The standard formatted record includes: fields that the server Website maps from the queried loss runs fields 430 and fields that the server Website adds during the mapping process 440.

The fields the server Website maps from the queried loss runs 430, in one embodiment, include: claim number, policy number, effective date, expiration date, insurance carrier, run date, line of business 410, claimant name, date of loss, claim status, paid losses, paid expenses, reserves, total incurred, details, worker's compensation indemnity paid, worker's compensation indemnity reserved, worker's compensation medical paid, worker's compensation medical reserved, worker's compensation expenses, worker's compensation deductible, and worker's compensation gross incurred. The worker's compensation fields 450 only contain data if the claim is a worker's compensation claim, that is, the line of business field 410 contains “Worker Compensation.”

The fields the server Website adds during the mapping process 440, in one embodiment, include: report number, entry number, insured name, insured street address, insured city, insured state, insured zip, insured FEIN, agent name, agent street address, agent city, agent state, agent zip, agent account information, carrier name, carrier street address, carrier city, carrier state, carrier zip, and carrier account information.

To store the queried loss runs into the standard formatted records, the server Website encompasses multiple protocols. Each protocol is capable of mapping one record format, a carrier's or carriers'record format, to the standard format. The server Website selects the appropriate protocol according to the carrier queried. The server Website, with that protocol, maps the fields from the queried loss run to the standard format. Thereafter, the server Website adds the additional fields.

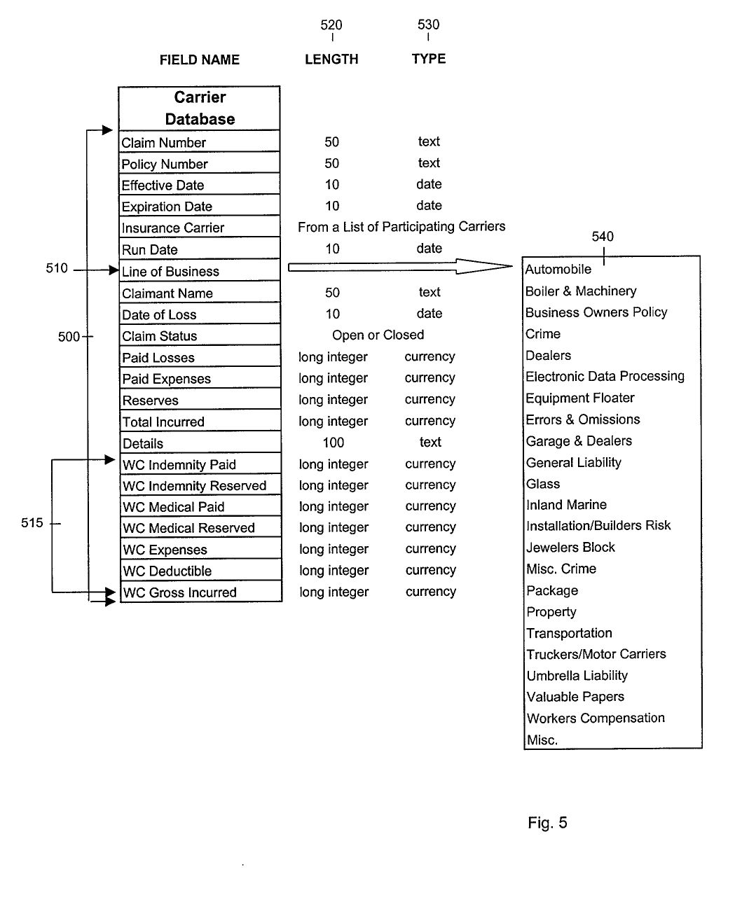

FIG. 5 shows one example of the fields found on a record in carrier database 500. The fields include: claim number, policy number, effective date, expiration date, insurance carrier, run date, line of business 510, claimant name, date of loss, claim status, paid losses, paid expenses, reserves, total incurred, details, worker's compensation indemnity paid, worker's compensation indemnity reserved, worker's compensation medical paid, worker's compensation medical reserved, worker's compensation expenses, worker's compensation deductible, and worker's compensation gross incurred. The worker's compensation fields 515 only contain data if the claim is a worker's compensation claim, that is, the line of business field 510 contains “Worker Compensation.” The length 520 and type 530 indicate the attributes of each field.

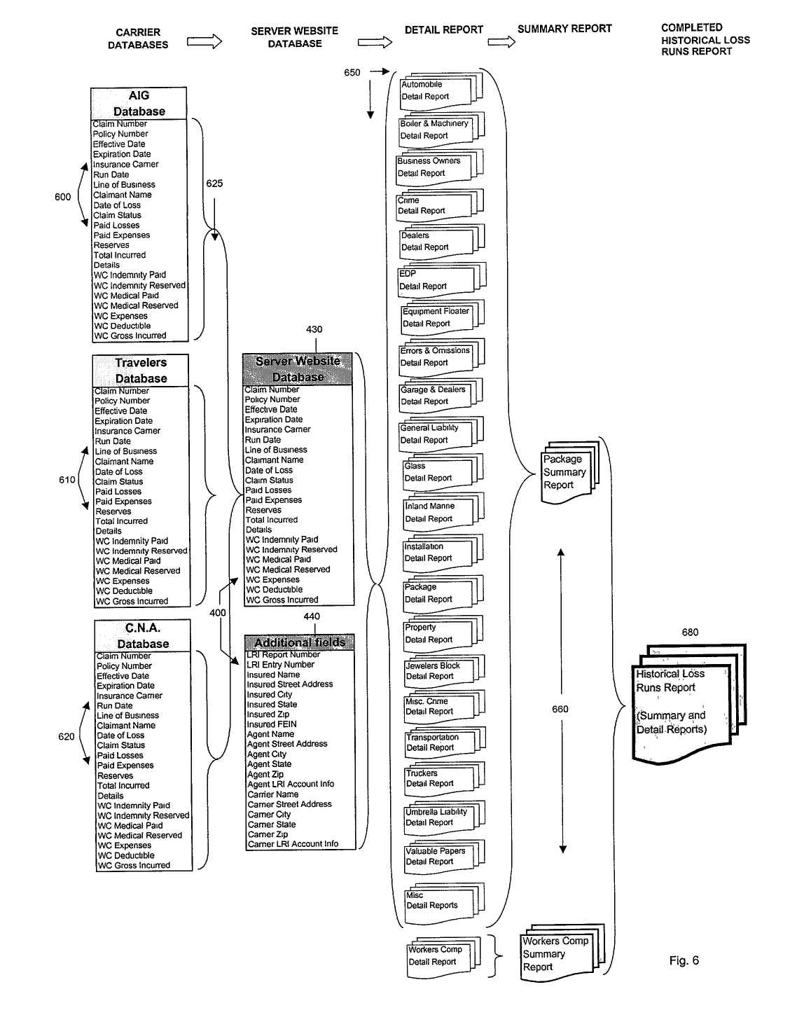

FIG. 6 shows the fields in the records of the AIG 600, Travelers 610, and C.N.A. 620 carrier databases. Carrier loss runs fields such as these are mapped with the appropriate protocol to fields in the standard format 430. Then, the additional fields, 440, are added. The standard formatted records are stored in the database on the server Website. As discussed above, the preferred embodiment implements a database on the server Website for storage.

### Generation of Reports

After querying the carrier databases and storing the standardized records, the server Website generates detail reports, summary reports, and then a combined historical loss runs report (Step 260). FIG. 6 represents the data flow from carrier databases to the generated reports. First, the server Website, using standard formatted loss runs, 400, generates detail reports for each line of business 650. Second, the server Website generates a summary report for each line of business 660. Finally, the detail reports and summary reports are combined into a combined historical loss runs report 680.

A detail report and summary report is created for each line of business 410 in which a loss run is received. Again referring to FIG. 5, the line of businesses may include but are not limited to: automobile, boiler & machinery, business owners policy, crime, dealers, electronic data processing, equipment floater, errors and omissions, garage and dealers, general liability, glass, inland marine, installation/builders risk, jewelers block, misc. crime, package, property, transportation, truckers/motor carriers, umbrella liability, valuable papers, workers compensation, and miscellaneous 540.

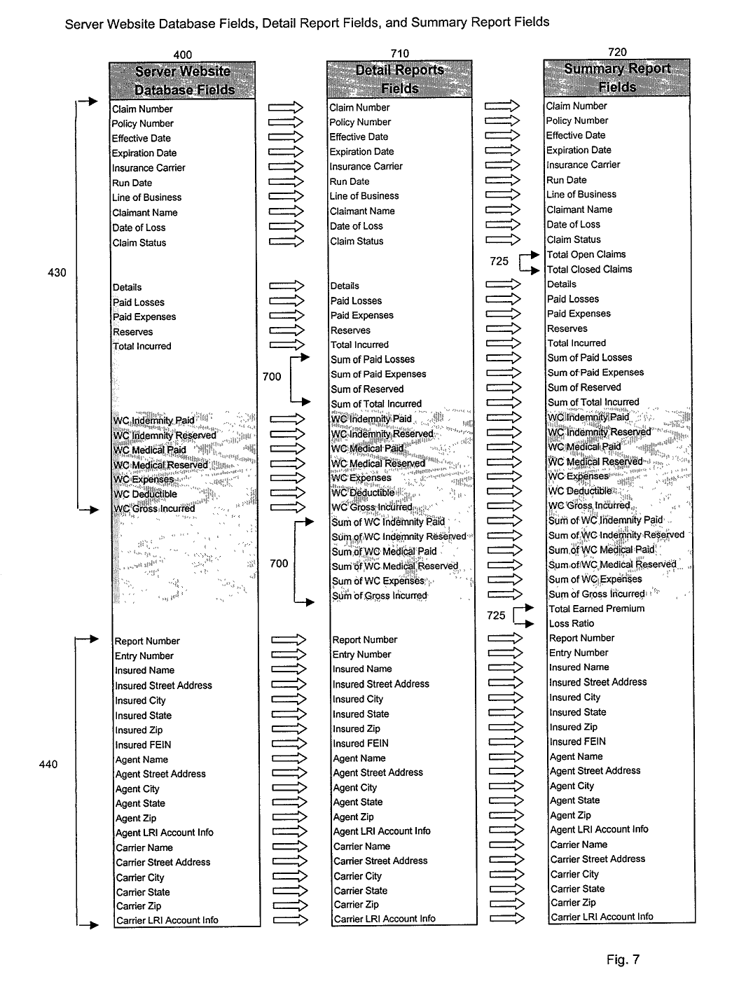

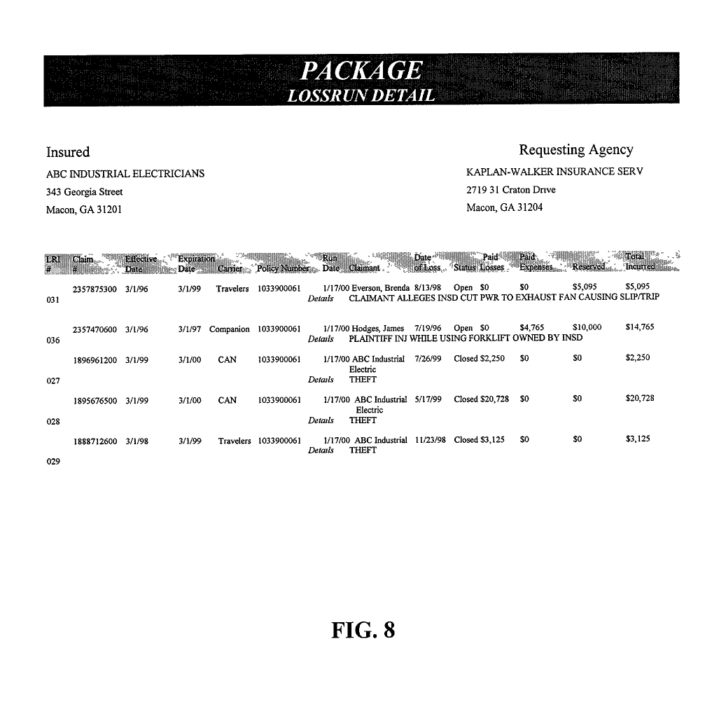

Referring to FIG. 7, the detail report fields 710 are the standard format fields 400 and additional fields 700. These additional fields produce summarized data; they include: the sum of paid losses, sum of paid expenses, sum of reserved, and sum of total incurred, sum of worker's compensation indemnity paid, sum of worker's compensation indemnity reserved, sum of worker's compensation medical paid, sum of worker's compensation medical reserved, sum of worker's compensation expenses, and sum of gross incurred 700. The server Website, using the detail report fields, generates detail reports. FIG. 8 is an example of a generated detail report. Detail reports may include but are not limited to: report numbers, claim numbers, effective dates, expiration dates, carriers, policy numbers, run dates, claimants, date of losses, status, paid losses, paid expenses, reserved, total incurred, and details. The detail reports disclose each claim in standardized form.

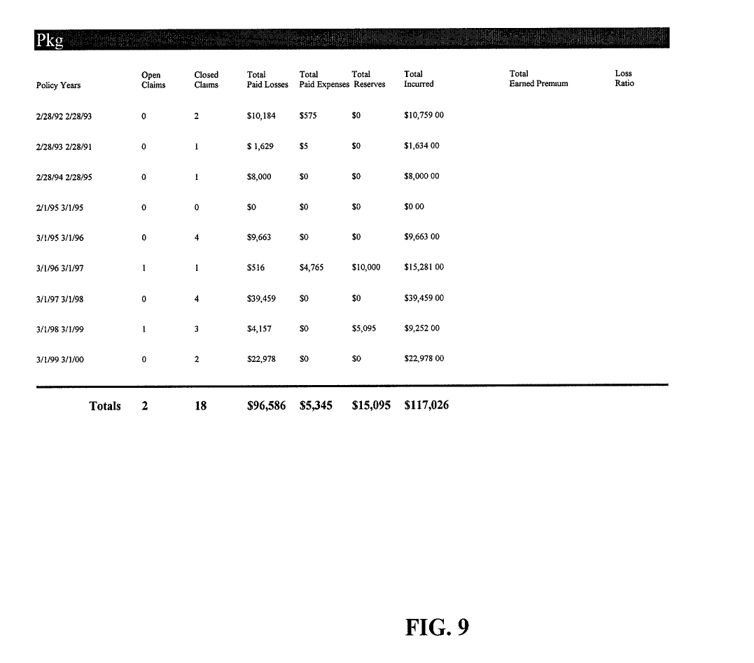

Again referring to FIG. 7, the summary report fields 720 are the detail report fields 710 and additional fields 725. These additional fields produce summarized data; they include: total open claims, total closed claims, total earned premium, and loss ratio. The server Website, using the summary report fields, generates summary reports. FIG. 9 is an example of a generated summary report. Summary reports may include but are not limited: to the policy years, the sum of open and closed claims, the total paid losses, the total paid expenses, the total reserves; the total incurred, and the total earned premium. The summary reports combine claims and carriers to present data in summarized form.

The reports described above are not intended to limit this invention. The spirit of this invention is to combine loss runs from multiple carriers over multiple years into a standardized report through the above described computer system. The reports may include different fields or be presented in a different form.

### Distribution

### Referring again to FIG. 3, after the reports are generated, the server

Website electronically distributes them (Steps 265 and 270). The server Website automatically emails the parties on the notification list that the reports are complete (Step 265). The emails include an URL address to the report and a Password. The parties, after linking to the Internet address via their browser and inputting the Password, view and print the reports 270. The invention is not limited to electronic distribution; the invention may implement other distribution methods, e.g., automatic facsimiled reports or mailed reports.

It should be understood that the foregoing pertains only to the preferred embodiments of the present invention, and that numerous changes may be made to the embodiments described herein without departing from the spirit and scope of the invention.

What is claimed is:

1. A computer-implemented method for generating historical claim loss data reports that combine loss data from multiple insurance carriers over multiple years for insured parties comprising the steps of:
inputting information about the insured onto a server Website;
obtaining an authorization from the insured party;
querying loss data from at least two carrier databases;
storing the queried loss data in a standard formatted form;
generating a standardized report, wherein the report combines loss data from the at least two carrier databases; and
distributing the reports to the user.

2. The method according to claim 1, wherein the step of inputting the information about the insured comprises inputting the information about the insured through a user interface on the server Website.

3. The method according to claim 1, further comprising the step of implementing a security procedure that limits access to predetermined users.

4. The method according to claim 3, wherein the step of implementing a security procedure comprises the steps of:
receiving a Login Name from the user;
receiving a Password from the user; and
verifying that the received Login Name and Password have authorization to enter the secured area.

5. The method according to claim 1, wherein before the step of inputting information about the insured onto a server Website the user, through a user menu driven interface on the server Website, chooses a report request.

6. The method according to claim 1, further comprising the step of flagging an account as authorized on the server Website, wherein the account is flagged on the server Website after the step of obtaining an authorization from the insured party is completed.

7. The method according to claim 1, wherein the step of obtaining an authorization from the insured party comprises the steps of:
generating authorization letters on an application on the server Website;
printing authorization letters;
obtaining insured signatures on letters;
returning authorization letters via facsimile; and
storing authorization letters.

8. The method according to claim 7, wherein the step of printing the authorization letters comprises of the user printing authorization letters which have unique tracking numbers or bar codes.

9. The method according to claim 8, wherein the step of storing the authorization letters comprises of routing the authorization letters according to account to storage areas.

10. The method according to claim 9, wherein the step of storing the authorization letters further comprises the steps of:
interfacing the routing system and the server Website; and
flagging the account on the server Website when the routing system has received all of the authorization letters for that account..

11. The method according to claim 1, wherein the step of querying loss data from at least two carrier databases comprises the steps of:
triggering the query at pre-determined times; and
querying only for the loss runs of flagged accounts.

12. The method according to claim 11, wherein the step of querying loss data from at least two carrier databases further comprises determining the appropriate protocol according to which carrier database is queried.

13. The method according to claim 1, wherein the step of storing the queried loss data in a standard formatted form comprises the steps of:
selecting the appropriate mapping scheme according to the carrier queried;
mapping the data fields of the carrier loss run data fields to fields in a standard formatted record; and
adding addition fields to that standard formatted record;.

14. The method according to claim 1, wherein the step of generating a standardized report comprises the steps of:
generating a detail report for each line of business; and
generating a summary report for each line of business, wherein the summary report combines at least two carriers within the same line of business.

15. The method according to claim 1, wherein the step of distributing the report to the user comprises the steps of:
inputting a notification list on the server Website;
emailing the parties on the notification list upon completion of the report; and
accessing reports via World Wide Web by members on the notification list.

16. The method according to claim 1, wherein the step of distributing the report to the user comprises the steps of:
inputting a notification list on the server Website;
emailing the parties on the notification list an URL address and a Password; accessing that Internet address;
receiving that Password;
verifying that that Password is an authorized Password; and
viewing the reports;

17. A computer system for generating historical claim loss data reports that combines loss data from multiple insurance carriers over multiple years for insured parties comprising of:
a server Website;
means for obtaining authorization from the insured party, wherein the authorization comprises of at two insurance carriers;
means for the server Website to query at least two insurance carrier databases;
means for the server Website to store varying formats of insurance carrier loss runs from a plurality of insurance carriers in a standard format;
means for generating standardized reports of those loss runs;
means for distributing the standardized reports to the user.

18. The computer system according to claim 17, further comprising of means for the server Website to implement security procedures that limit access to predetermined users.

19. The computer system according to claim 17, further comprising of authorization letters containing unique tracking numbers or bar codes.

20. The computer system according to claim 17, further comprising of a routing system, wherein the routing system routes returned authorization letters according to their tracking number or bar code.

21. The computer system according to claim 20, further comprising of an interface between the server Website and the routing system, wherein the interface allows the server Website to determine whether all the authorization letters for an account have been returned and routed.

22. The computer system according to claim 17, further comprising of:
summary reports that combine the claim loss data from a plurality of carriers for each line of business; and
detailed reports that disclose each claim for each line of business.
